(19) United States
(12) Patent Application Publication
(10) Pub. No.: US 2022/0193689 A1
(43) Pub. Date: Jun. 23, 2022

(54) Auto-feed Paper Shredder with Dual Bottom Inputs

(71) Applicant: Herman CHANG, Rancho Dominguez, CA (US)

(72) Inventor: Herman CHANG, Rancho Dominguez, CA (US)

(21) Appl. No.: 17/558,422

(22) Filed: Dec. 21, 2021

Related U.S. Application Data
(60) Provisional application No. 63/129,078, filed on Dec. 22, 2020.

(51) Int. Cl. B02C 18/22; B02C 18/00

(52) U.S. Cl. CPC B02C 18/2283; B02C 18/0007

(57) ABSTRACT

A dual auto-feed paper shredder provides a housing open at a top side to allow access to a paper compartment disposed within the housing. The paper compartment includes a bottom surface defining two side-by-side paper stations and a centrally located input slot extending across the bottom surface. Each paper station is configured to accommodate one stack of paper disposed above the input slot. Two sets of counter-rotating spaced apart rollers disposed on either side of the input slot. Each set is associated with a particular one of the paper stations. The housing includes an internal compartment configured to hold a shredding mechanism disposed below the input slot such that sheets of paper pass through the input slot into the shredding mechanism. At least one lid is hingedly connected to the housing, and is rotatable between fully open and fully closed configurations. The at least one lid is disposed over the paper compartment in the fully closed configuration.

### CROSS-REFERENCE TO PRIOR APPLICATIONS

The present application is based on and claims the priority and benefit of U.S. Provisional Patent Application No. 63/129,078, filed Dec. 22, 2020, which is incorporated herein in its entirety.

### BACKGROUND OF THE INVENTION

### Area of the Art

The present invention is in the area of office machines and is more specifically directed to paper shredders with dual bottom inputs.

### DESCRIPTION OF THE INVENTION

Although the world professes to be moving to the “paper-free” office and although emails often have a “Save a tree—Please don't print” banner, most business operations continue to rely on paper. With the current lack of overall cyber-security so that foreign hackers seem to be able to penetrate even super-secret government agencies, it is somewhat difficult (even foolhardy) to totally rely on computer files to ensure secrecy and security. Nevertheless, paper copies are also far from secure. While diligent protection of pages containing sensitive information can discourage leaks, perhaps the greatest challenge to ensuring security of printed documents continues to be their disposal. Sooner or later documents must be thrown away and since it is impossible to equip each worksite with a furnace (not to mention the ensuing environmental problems), other means must be taken to render discarded documents illegible. The presently preferred means of achieving this is the ubiquitous paper shredder.

While there are a variety of slightly different paper shredding devices presently available, they all work in more or less the same manner. A shredding mechanism is positioned adjacent to an input slot so that any papers inserted through that slot interact with the shredding mechanism. In the most common configuration, blades mounted on a pair of counter-rotating shafts pull in sheets of paper inserted between the blades and cut the sheets of paper into more or less tiny pieces. While it is theoretically possible to reassemble those pieces, doing so is essentially impossible. Hacking computers is a much more efficient way of stealing information than attempting to reassemble tiny bits of paper (assuming the thief can even find all of the paper pieces).

Many conventional paper shredders suffer from two related problems. First, the shredding capacity is limited by the need to keep equipment compact and the prices reasonable. While the units can easily handles a single or even 5-10 sheets of paper (or more in some cases), if too many sheets are simultaneously fed into the paper shredder, the unit is likely to jam and/or overheat. This limitation on input sheet number leads to the second problem which is that, because of the limited input shredding capacity, the user must stand at the paper shredder machine and slowly feed an acceptable number of paper sheets into the paper shredder. This can be tedious at best and may result, when there is a large number of sheets to be shredded, in the user simply giving up and tossing the confidential documents into the trash without even shredding them.

Both of these problems can be solved by some sort of auto-feed device that feeds sheets of paper into the shredding mechanism at a fixed rate. The first problem is solved because the auto-feed can be designed to never feed an excess number of sheets into the mechanism. The second problem is solved because the auto-feed mechanism can accept an entire stack of paper and shred it without any oversight by the user. Large, heavy duty auto-feed shredders such as the shredder disclosed in U.S. Pat. No. 8,074,912, the contents of which are incorporated herein by reference, are available. These devices are relatively massive units that accept a large stack of paper (often a ream or more of paper) to be shredded that is placed within a shredding compartment. The stack of paper is placed onto a pair of counter-rotating rollers, and the bottommost paper sheet in the stack is individually folded and pinched in its middle by the rollers, drawn from the bottom of the stack and fed into a shredding mechanism located below the rollers. This repeats with the sheet of paper that has now become the bottommost paper sheet in the stack, and so on as the individual sheets of paper in the stack are processed in the foregoing manner.

The device of U.S. Pat. No. 8,074,912 is made more complex because a preferred embodiment of the device has a complex dual door arrangement that closes the shredding compartment. In spite of the complexity, an advantage of the dual door configuration is that the point at which the two doors meet is exactly above and aligned with the counter-rotating rollers thereby providing an input slot so that single sheets of paper can be shredded when the shredding compartment is not occupied without having to open the shredding compartment doors.

Accordingly, there is a need for an improved paper shredder. There is a further need for a compact paper shredder. There is also a need for a paper shredder at a reasonable price. There is a still further need for a compart paper shredder with sufficient (if not high) shredding capacity. There is a further need for an auto-feed device that feeds sheets of paper into a shredding mechanism of a paper shredder at a fixed rate. There is a further need for a paper shredder that can shred various sizes of paper. There is an additional need for a paper shredder that is easier to manufacture, assemble, adjust, and maintain. The present invention satisfies these needs and provides other related advantages.

### SUMMARY OF THE INVENTION

An embodiment of the present invention provides an improved paper shredder. An embodiment of the present invention provides a compact paper shredder. An embodiment of the present invention provides a paper shredder at a reasonable price. An embodiment of the present invention provides a compart paper shredder with sufficient (if not high) shredding capacity. An embodiment of the present invention provides an auto-feed device that feeds sheets of paper into a shredding mechanism of a paper shredder at a fixed rate. An embodiment of the present invention provides a paper shredder that can shred various sizes of paper. An embodiment of the present invention provides a paper shredder that is easier to manufacture, assemble, adjust, and maintain. An embodiment of the present invention satisfies these needs and provides other related advantages.

In an embodiment of the present invention, a dual auto-feed paper shredder includes a housing open at a top side to allow access to a paper compartment disposed within the housing. The paper compartment includes a bottom surface defining two side-by-side paper stations and a centrally located input slot extending across the bottom surface. Each paper station is configured to accommodate one stack of paper disposed above the input slot. Two sets of counter-rotating spaced apart rollers are disposed on either side of the input slot. Each set is associated with a particular one of the paper stations. The housing includes an internal compartment configured to hold a shredding mechanism disposed below the input slot such that sheets of paper pass through the input slot into the shredding mechanism. At least one lid is hingedly connected to the housing, and is rotatable between fully open and fully closed configurations. The at least one lid is disposed over the paper compartment in the fully closed configuration.

In another embodiment of the present invention, The dual auto-feed paper shredder of claim 1, wherein the at least one lid includes a manual feed input slot aligned with the input slot of the paper compartment when the at least one lid is in a fully closed configuration.

In yet another embodiment of the present invention, each set of counter-rotating spaced apart rollers is configured to operate independent of the other set of counter-rotating spaced apart rollers.

In still another embodiment of the present invention, the at least one lid includes a spring-loaded platen configured to maintain contact between the stack of paper and the rollers when the at least one lid is closed after a stack of paper has been placed into at least one of the paper station.

In another embodiment of the present invention, the dual auto-feed paper shredder further includes a sensor configured to detect paper in the paper compartment and activate the shredding mechanism when paper is detected so that the rollers counter-rotate and pull a bottom sheet of paper from the stack of paper and move that sheet of paper through the input slot and into the shredding mechanism.

In still another embodiment of the present invention, the at least one lid includes two lids where each lid is individually connected to the housing such that each lid is moveable between the fully open and fully closed configurations independent of the other lid.

In a further embodiment of the present invention, each lid includes a manual feed input slot aligned with the input slot of the paper compartment when the lid is in a fully closed configuration where the manual feed input slots of the lids are aligned when the lids are in the fully closed configuration, and where the aligned manual feed input slots are configured to allow either two separate sheets of paper to be passed side-by-side through the aligned manual feed slots into the paper compartment and through the input slot to the shredding mechanism or a single oversized sheet of paper to be passed through the aligned manual feed slots into the paper compartment and through the input slot to the shredding mechanism.

Other features and advantages of the present invention will become apparent from the following more detailed description, taken in conjunction with the accompanying drawings, which illustrate, by way of example, the principles of the invention.

### DESCRIPTION OF THE FIGURES

The various present embodiments now will be discussed in detail with an emphasis on highlighting the advantageous features with reference to the drawings of various embodiments. The illustrated embodiments are intended to illustrate, but not to limit the invention. These drawings include the following figures, in which like numerals indicate like parts:

FIG. 1 illustrates a top plan view of a paper shredder in accordance with an embodiment of the present invention;

FIG. 2 is a front elevation view of the paper shredder of FIG. 1, showing two separate standard size sheet(s) of paper with arrows indicating the direction the sheet(s) are being manually fed/lowered into respective input slots on the top of the lids of the paper shredder;

FIG. 3 is a front elevation view of the paper shredder of FIG. 1, showing a single oversized sheet(s) of paper with an arrow indicating the direction the sheet(s) are being manually fed/lowered into input slots on the top of the lids of the paper shredder; and

FIG. 4 is a right side elevation cross-sectional view of the paper shredder of FIG. 1, showing the lids in the closed configuration.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a compact, high capacity and easy to operate auto-feed paper shredder that operates on the principle of two sets of counter-rotating feed rollers. The following detailed description describes the present embodiments, with reference to the accompanying drawings. In the drawings, reference numbers label elements of the present embodiments. These reference numbers are reproduced below in connection with the discussion of the corresponding drawing features. It is to be understood that the figures and descriptions of the present invention have been simplified to illustrate elements that are relevant for a clear understanding of the present invention, while eliminating, for the purpose of clarity, many other elements found in paper shredders. Those of ordinary skill in the pertinent arts may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the pertinent arts.

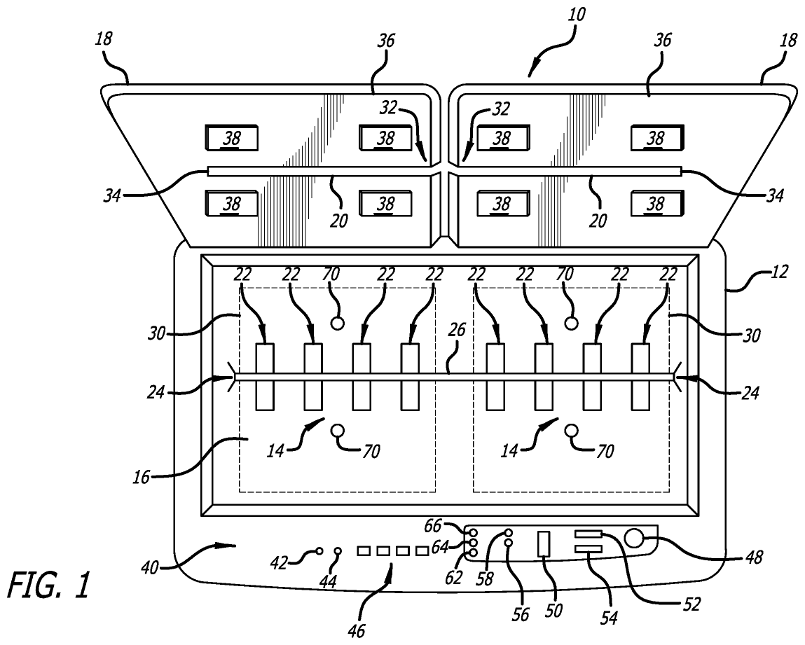

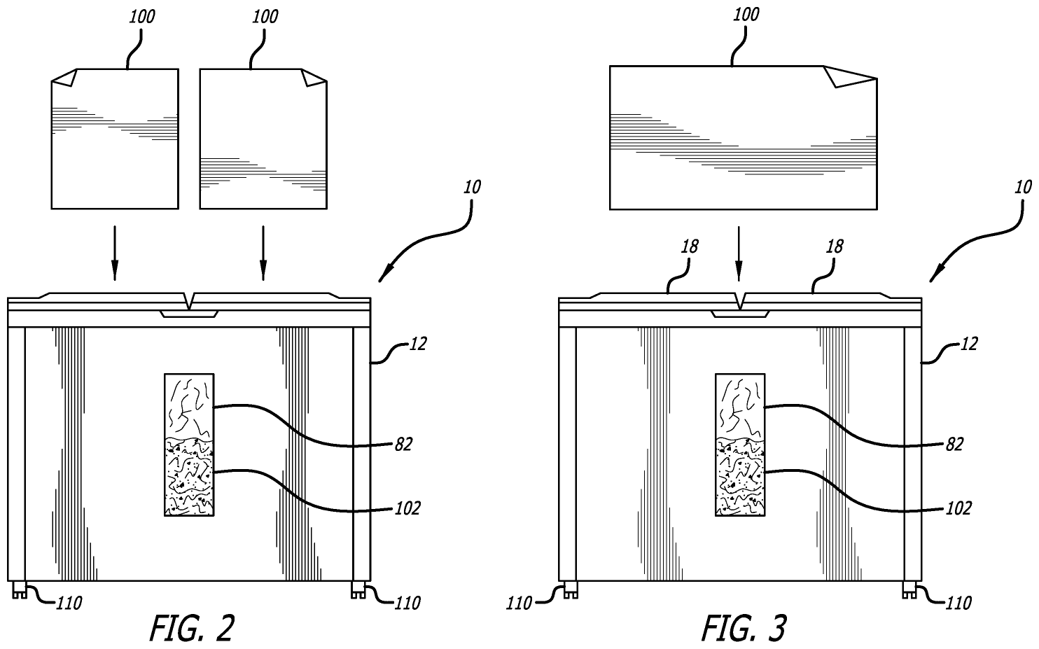

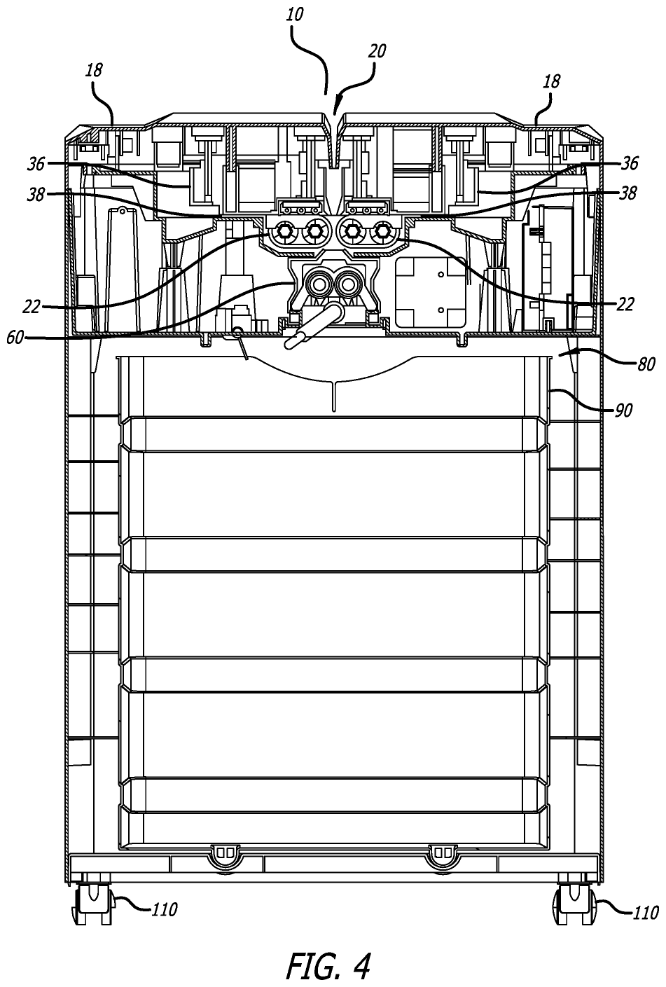

As shown in FIGS. 1-4 for purposes of illustration, an embodiment of the present invention resides in a paper shredder assembly 10 that includes a dual door-dual auto-feed arrangement. The assembly 10 includes a housing 12, two (2) adjacent auto-feeders 14. Each auto-feeder includes a set 14 of a number of auto-feeder rollers or belts disposed at the bottom of a paper compartment or auto-feed tray 16. The assembly 10 further includes two (2) lids 18 with each lid 18 hingedly connected to the housing 12. Each lid 18 is independently rotatable about a hinged connection with the housing 12 from the other lid 18. Each lid 18 is rotatable between a fully open configuration (seen in FIG. 1) and a fully closed configuration (see in FIGS. 2 and 3). Each lid 18 is generally disposed over a particular one of the two (2) sets 14 of auto-feeder rollers or belts. In the alternative, each lid 18 may include a spring-loaded platen 36 having pressure plates 38. The spring-loaded platen 36 engages a bottom surface of the lid 18 such that, when the lid 18 is in a closed configuration after a stack of paper 100 has been placed within a paper station 30 of the auto-feed paper tray 16 directly under that particular lid 18, contact between the stack of paper 100 and the rollers (or belts) of the set 14 associated with that particular paper station 30 is maintained by the pressure plates 38 of the spring-loaded platen 36 engaging and pushing downward on the top of the stack of paper 100.

Each lid 18 includes a manual feed input slot 20 sized and shaped to allow one or more sheets of paper 100 to be feed through the slot 20 (if the lid 18 includes a spring loaded platen 36, the manual feed input slot 20 extends through the spring-loaded platen 36 such that paper can pass through the lid 18 into the auto-feed tray 16 and into the input slot 26 aligned with and below the manual feed input slot 20). Each slot 20 includes an open end 32 on one side of the particular lid 18 that slot 20 is located on, and a closed end 34 located a certain distance from the open end and a certain distance from a side of that particular lid 18 that is opposite the side the open end of the slot 20 is located. As seen in FIG. 1, the length of each slot 20 extends more than halfway across the lid 18 that particular slot 20 is associated with, and is at least equal to a width of a standard sized paper 100 intended to be shredded (the “width” generally being viewed as being the smaller dimension of the paper than the “length” of the paper). Various size paper 100 can be inserted through the slots 20 including, but not limited to, standard size paper (e.g., US letter size (8.5 inches×11 inches), US legal size (8.5 inches×14 inches), US ledger (11 inches×17 inches), A4 size (8.27 inches×11.69 inches (210×297 mm)), and the like), and oversized paper. An example of oversized paper is any document wider than 8.5 inches on the document's shortest side. Other examples of oversized paper are stacks of tabloid-sized, wide-format continuous dot-matrix documents, wide-format spreadsheet documents, architectural/engineering plans, etc. In the alternative, a latch mechanism (not shown) may be used to hold the lids 18 together as a single lid such that the lids 18 open and close in unison. A single stack of paper 100 (e.g., standard US letter size (8.5 inches×11 inches)) can be placed within the auto-feed tray 16 over a particular set of the two (2) sets of auto-feeder rollers 14. Each set 14 defines a portion of a particular paper station 30. As seen in FIG. 1, the general area of each paper station 30 is only symbolically illustrated by broken lines, and is not to be construed as being drawn to scale. In this manner, two (2) separate stacks of US letter size paper 100 can also be put into the auto-feed tray 16 adjacent to each other (i.e., side-by-side), with each stack of paper 100 disposed over a particular set of the two (2) sets of auto-feeder rollers 14 (i.e., each stack of paper 100 is associated with a particular paper station 30). This allows the dimensions of the auto-feed tray 16 to be increased so that, for example, two stacks of paper 100 can be accommodated side-by-side. One dimension (for example, the back-to-front distance) of the housing 12 of the paper shredder assembly 10 is generally controlled by the size of the auto-feed tray 16 that is, in turn, controlled by the length of the paper stack (e.g., 11 inches for standard US letter size) while the other dimension (for example, the side-to-side distance) of the housing 12 of the paper shredder assembly 10 is generally controlled by the size of the auto-feed tray 16 that is, in turn, controlled by the width of the stack (e.g., 8.5 inches for standard US letter size). Therefore, placing two (2) stacks side-by-side increases the side-to-side width of the auto-feeder tray 16 by at least 8.5 inches without altering the other dimensions of the shredder and doubling the capacity of the paper shredder assembly 10.

Each auto-feeder set 14 pulls paper 100 from a paper stack located within the auto-feed tray 16. As discussed herein, the auto-feeder tray contains two (2) side-by-side paper stations 30, with each paper station 30 sized to accommodate a stack of papers 100 (e.g., standard letter size (8.5 by 11 inch) paper though each paper station 30 can readily be designed to accept other standard paper sizes (legal, A4, etc.), and the paper stations 30 can be designed such that each paper station 30 can accept a different size of paper than the other station 30). Alternatively, the auto-feed tray 16 can be constructed with adjustable guides so a variety of different paper sizes can be accommodated. This allows the assembly 10 to be simultaneously loaded with stacks of two different sized paper sheets. The floor of each paper station 30 contains centrally (more or less) located (in terms of the paper stack) sets 14 of counter rotating rollers (or belts), with one roller (or belt) of each pair 22 on either side of the input slot 26 which is coincident with the input to the shredding blades disposed within the housing 12 below the auto-feed tray 16.

If rollers are used, each of the counter-rotating rollers rotates towards the input slot 26, that is, the roller on one side of the slot 26 rotates counter clockwise while the roller on the opposite side of the slot 26 rotates clockwise. The net effect is that the rollers grasp the bottom sheet of paper 100 of the stack and cause the paper 100 to fold between the rollers so that the fold line is forced into the slot 26 and down into the input of the shredding mechanism. As soon as one sheet of paper 100 clears the rollers, the next sheet of paper 100 is grabbed and forced into the shredding mechanism, pushing the first sheet along if any of it lags in the input slot 26. This basic description suggests that the input slot 26 is lined on each side by a single roller the length of the slot 26. While such a configuration is operative, it is also possible to replace a single roller with several smaller (shorter) rollers mounted along the same shaft. The rollers can be spaced apart so long as considerable regions exist where rollers on either side of the input slot 26 overlap. In addition, some of the rollers can be disposed on bearings so as to rotate independently of the shaft and act as follower rollers. Further, the rollers can be replaced with counter rotating belts which operate in the same way as the rollers but contact the same, smaller, or larger area of the paper sheet (depending on the width of the belt).

The feeding rollers (or belts) can be parallel to the long axis or to the short axis of the paper sheet 100. It is most common to have the rollers (or belts) parallel to the short axis because this reduces the length of the shredding mechanism. The shredding mechanism must have blades disposed along a shaft at least as long (in practice slightly longer) than the width of a sheet to be shredded. If the feeding rollers (or belts) are parallel to the short axis of the sheet, the width of the sheet (the short axis) will control the length of the shredding mechanism. If the feeding rollers are parallel to the long axis of the sheet, the shredding mechanism must be at least as long as the longest sheet to be shredded. A single double length shredding mechanism can service both auto-feeders or two normal length shredding mechanisms can be placed side by side.

Each auto-feed roller set 14 includes several pairs 22 of counter-rotating rollers or belts (e.g., an illustrative auto-feed roller set 14 is shown as having four (4) pairs 22 of rotating rollers or belts in FIG. 1). Each pair 22 comprises two (2) rollers or belts, with each roller or belt disposed on an opposite side of the input slot 26 from the other. A shredder throat 24 is longitudinally disposed along a central length of the bottom of the auto-feed tray 16, with an elongated input slot 26 disposed at the bottom of the shredder throat 24. As seen in FIG. 1, the input slot 26 is disposed between the rollers or belts of each pair 22 of counter-rotating rollers or belts.

In one example of auto-feed shredding, two stacks of sheets of paper 100 are placed side-by-side in respective paper stations 30 of the auto-feed tray 16 when the lids 18 are open. Each of the side-by-side stacks of sheets of paper 100 is centered over the input slot 26, and over a particular one of the sets 14. The lids 18 are closed. The assembly 10 may need to be manually activating to start the shredding of the papers 100 or the assembly 10 may be set such that shredding automatically begins once the lids 18 are closed. Each counter-rotating pair 22 of a particular set 14 grabs a single sheet of paper 100 from the bottom of the stack disposed over that particular set 14. The pairs 22 pull the sheet 100 downwards, folding the sheet 100 as the sheet 100 moves downwards into the throat 24, and propel the sheet 100 through the input slot 26 into a conventional counter-rotating blade shredding mechanism 60 located beneath the auto-feed tray 16 within the housing 12.

In another example of auto-feed shredding, when a single stack of oversized sheets of paper 100 is placed in the auto-feed tray 16 when the lids 18 are open. The stack of oversized sheets of paper 100 is centered over the input slot 26, and generally over both of the sets 14. The lids 18 are closed. The assembly 10 may need to be manually activating to start the shredding of the papers 100 or the assembly 10 may be set such that shredding automatically begins once the lids 18 are closed. Each counter-rotating pair 22 of the sets 14 grabs a single sheet of paper 100 from the bottom of the stack disposed over the sets 14. The pairs 22 pull the sheet 100 downwards, folding the sheet 100 as the sheet 100 moves downwards into the throat 24, and propel the sheet 100 through the input slot 26 into a conventional counter-rotating blade shredding mechanism 60 located beneath the auto-feed tray 16 within the housing 12.

It will be appreciated that the conventional counter-rotating blade shredding mechanism axis can be either parallel or perpendicular to the long axis of the paper sheet 100. Where the conventional counter-rotating blade shredding mechanism is oriented with its long axis perpendicular to the long axis of the paper sheets 100, the conventional counter-rotating blade shredding mechanism can generally equal to the length of the housing 12 of the entire auto-feeder arrangement (that is, twice the length of a conventional shredder mechanism). Alternatively, two “normal” length shredding mechanisms can be placed side-by-side below the input slot 26. If the rollers or belts of the pairs 22 are oriented parallel to the long axes of the paper sheets 100, then two 11 inch (for standard US paper sizes) shredding mechanisms would be located side-by-side.

With regard to manual feeding of paper 100 into the auto-feed tray 16, the slot 20 on each lid 18 is wide enough to accommodate 1-12 sheets of “stacked” paper 100 (e.g., US letter size, US legal size, A4 size, etc.). In one example of manual-feed shredding, as seen in FIG. 2, two (2) separate but adjacent stacks of sheets of paper 100 may be feed simultaneously “side-by-side” through the manual feed slots 20 of the lids 18 when the lids 18 are closed. A single user may hold papers 100 in each hand to feed the papers 100 through the slots 20 or two users may each hold their own stacks of paper 100 and individually feed their stack of papers 100 through one of the slots 20. The slots 20 are centered over and aligned with the input slot 26. The assembly 10 may need to be manually activated to start the shredding of the papers 100 or the assembly 10 may be set such that shredding automatically begins once a sensor detects papers 100 passing into the throat 24 or input slot 26. Each counter-rotating pair 22 of a particular set 14 may assist with feeding paper 100 into the input slot 20 by grabbing the paper 100, pulling the sheet(s) of paper 100 downwards into the input slot 26 into the conventional counter-rotating blade shredding mechanism 60 located beneath the auto-feed tray 16 within the housing 12.

The slots 20 on the lids 18 are generally aligned with each other, with the open end of a slot 20 on one of the lids 18 generally aligned with and adjacent to an open end of a slot 20 on the other one of the lids 18 when both lids 18 are in a fully open configuration or a fully closed configuration. The alignment of the two (2) slots 20 creates a “superslot” that allows an oversized sheet(s) of paper 100 to be manually fed through the manual feed “superslot” 20 into the auto-feed tray 16. In another example of manual-feed shredding, as seen in FIG. 3, a single stack of oversized sheets of paper 100 may be feed through the manual feed “superslot” 20 of the lids 18 when the lids 18 are closed. A single user may hold the papers 100 in one or both hands to feed the papers 100 through the slots 20. The “superslot” 20 is centered over and aligned with the input slot 26. The assembly 10 may need to be manually activated to start the shredding of the papers 100 or the assembly 10 may be set such that shredding automatically begins once a sensor detects papers 100 passing into the throat 24 or input slot 26. Each counter-rotating pair 22 of one or both sets 14 may assist with feeding the oversized paper 100 into the input slot 20 by grabbing the paper 100, pulling the sheet(s) of paper 100 downwards into the input slot 26 into the conventional counter-rotating blade shredding mechanism 60 located beneath the auto-feed tray 16 within the housing 12.

It will be appreciated that the height dimension of this type of paper shredder assembly 10 is controlled by the configuration of a shredding mechanism 60 disposed within an internal compartment 50 of the housing 12 as well as the allowable height of a stack of paper. Generally, it is desirable to accommodate at least one ream (i.e., 500 sheets) of paper which is approximately two (2) inches thick. Compared to the shredding mechanism and paper compartment lid, this is a relatively modest dimension. Making the paper compartment or auto-feed tray 16 deeper to accommodate two or more stacked sheets of paper 100 is generally not a problem. However, the side-by-side stack configuration doubles capacity for any given paper compartment height making a low profile, high-capacity shredder feasible. The back-to-front distance of the housing 12 can also be controlled by placement of a control assembly 40 on a top of the housing 12 adjacent to the lids 18 (as seen in FIG. 1). In the alternative, the control assembly 40 may be positioned on a front of the housing 12, on any of the other sides of the housing 12, or anywhere desired on the assembly 10 for ergonomics and convenience of the user. The control assembly 40 includes various electronics (e.g., a processor, a memory, etc.) configured to allow a user to operate the paper shredder assembly 10 by providing buttons/switches for operation of the assembly 10 and indicators to inform a user about various conditions of the assembly 10. For example, the control assembly 40 includes pin entry assembly 46 providing four buttons/switches for entry of a four-digit personal identification number (PIN) to lock the lids 18 of the assembly 10 (when the assembly 10 includes a locking mechanism for locking the lids 18 in a closed configuration). There is an indicator (e.g., a red LED) 42 for indicating a “locked” condition of the lids 18, and another indicator (e.g., a green LED) 44 for indicating an “unlocked” condition of the lids 18. Likewise, the control assembly 40 may include an on/start or “power” button/switch 48 to power on the assembly 10, an off/stop button/switch 50 to turn off the assembly 10, a forward button/switch 52 to set the direction of the shredding mechanism 60 and/or rollers/belts 22 in a forward direction, a reverse button/switch 54 to set the direction of the shredding mechanism 60 and/or rollers/belts 22 in a reverse direction (e.g., in case of a paper jam). Other indicators may be on the panel of the control assembly 40 including a door open indicator (e.g., a red LED) 56 (e.g., to indicate that a lid 18 or front door of the housing 12 is open, etc.), an overload indicator (e.g., a red LED) 58 (e.g., to indicate that too much paper 100 has been placed within the paper compartment 16, too much shredded paper 102 is contained within the waste bin 90, etc.), a power indicator (e.g., green LED) 62 (e.g., to indicate that the assembly 10 is powered up), a bin full indicator (e.g., a red LED) 64 (e.g., to indicate that the waste bin 90 is full, etc.) and, an overheat indicator (e.g., a red LED) 66 (e.g., to indicate that the shredding mechanism 60 or motor is overheating).

To operate the shredder, the hinged lids 18 of the paper compartment or tray 16 are opened which activates an interlock switch (not shown) thereby preventing the shredder motor (not shown) from starting. As set forth above, a stack of papers 100 is then placed in either one or both of the paper stations 30 within the compartment or tray 16. The lids 18 are then closed which returns power to the shredder motor. The paper compartment 16 also contains document sensors 70 that detect the presence of paper 100 in each of the side-by-side paper stations 30. If paper 100 is present in at least one of the paper stations 30, the shredder motor activates and sheets of paper 100 are pulled from the bottom of the stack and fed into the shredder throat 24. Sensors (not shown) within the throat 24 detect the presence of paper 100 to ensure that the motor continues to run so long as paper remains in the throat 24. The sensors within the throat 24 are tied into the control assembly 40. Usually, a delay circuit (not shown) tied into the control assembly 40 keeps the motor running for a set period of time (usually a few seconds) after the shredder throat sensors report that the throat 24 is clear of paper 100. This ensures that all the paper 100 is shredded when the final paper sheet 100 is pulled into the throat 24 so as to leave no partially shredded fragments in the shredding mechanism. If two shredding mechanisms are placed side-by-side, the sensors may activate only the particular shredding mechanism beneath the paper stack when only a single stack is placed into the paper compartment or tray 16.

The counter-rotating feed rollers or belts of the sets 14 can be designed to operate in several different manners. For example, the simplest mechanism is to power both sets 14 of rollers or belts by means of a transmission or linkage connected to the shredder motor. In this way, whenever the shredder motor activates, the feed rollers or belts operate and if both paper stacks 100 are loaded, sheets of paper 100 will be pulled off of both of the stacks until both of the stacks are consumed. Because the shredding mechanism can readily handle several sheets of paper 100 simultaneously and because the counter-rotating feed rollers of the sets 14 pull a single sheet at a time from the bottom of the stack, the shredding mechanism is rarely (if ever) overloaded. This can also be accomplished by having the rollers or belts powered by one or two separate motors or by inserting electrically operated clutches into the roller drive train. This allows complete control over the shredding of each stack. This can be important where the paper stations 30 have been loaded with particularly heavy weight stock which might tend to overburden the shredding mechanism. In that case, the assembly 10 can be equipped with a priority switch that causes one stack to be completely shred before shredding of the second stack commences.

Some type of control of the shredding feed rollers can also be important when a paper jam occurs. Because the auto-feeder feeds only a single sheet at a time, a jam is quite unlikely—nevertheless, the unlikely may occur. Generally, when a jam occurs in a paper shredder, the user operates a switch that reverses the shredding mechanism so that the jammed paper can be backed out from the shredding mechanism. For the reversing process to be effective, the user should be able to pull the offending paper from the mechanism. This means that the throat 24 or input slot 26 should not be blocked by a paper stack even if the paper feeding rollers or belts are no longer attempting to force additional sheets of paper into the shredding mechanism. Therefore, a preferred design is to inhibit the reversal process until the paper sensor indicates that the paper stacks have been removed from the paper compartment or tray 16. If the feeding rollers are directly linked to the shredder motor, they will automatically reverse direction when the motor reverses and may aid in clearing paper from the throat. If there are separate motors or a clutch system operating one or more of the roller pairs separately, it may be advantageous to also reverse those motors. In addition, a release mechanism (not shown) can be provided that allows the rollers to be moved apart (or even removed entirely) to make it easier to access a paper jam.

As discussed above, the lids 18 are equipped with manual feed input slots 20 that align with the sets 14 of feed rollers or belts. This allows the user to feed single sheets of paper 100 into the shredder without opening the lid 18 so long as there is no stack of paper already loaded beneath the slot 20. If there is a stack of paper undergoing shredding, the user will not be able to effectively use the input slot 20 because the pathway to the shredding mechanism is blocked by the paper stack. Unless there is a large shredding job being processed (both paper stations 30 within the paper shredding compartment or tray 16 being filled), one of the manual feed input slots 20 may be available for input of one or more sheets of paper 100. The same sensors 70 that detect the presence of a paper stack can also operate a red/green LED (not shown) adjacent to each input slot 20. If there is no stack present below the manual feed input slot 20, the LED will be green indicating that the slot 20 can be used. If the LED is red, that particular slot 20 cannot be used.

Optical (or other appropriate sensors) sensors (e.g., document sensors 70) monitor both the paper stations 30 and the shredder throat 24. These sensors are part of the control assembly 40. Some of these sensors detect the presence of a stack in one of the paper stations 30 (e.g., the document sensors 70) and activate the shredding mechanism if the shredding compartment lids 18 are properly closed. The throat sensors detect a shreddable object in the throat 24 and activate the shredding mechanism if it is not already active (e.g., when the sheet of paper 100 to be shredded comes from the input slot 20 in the shredding compartment lids 18). Sensors based on mechanical, acoustical or any other physical principle can be used. The rotating blades of the shredding mechanism then pull in the paper and shred it. The resulting fragments fall into a waste bin or waste container 90 within the housing 12 that is located below the shredding mechanism. After the paper clears the throat 24, the sensors there are no longer activated, but a delay circuit ensures that the shredding mechanism continues to operate for a few additional seconds to allow all of the paper 100 to be completely shredded with the shredded paper 102 falling into the open top waste bin or waste container 90 positioned under the shredding mechanism 60. The shredded paper 102 in the waste container 90 can be visible through a window 52 in the front of the housing 12 if the waste container 90 is made of a transparent material. Alternatively, a front portion of the waste container 90 can form a portion of the front of the housing 12.

The shredding mechanism 60 is designed to handle several sheets of paper simultaneously while the auto-feeder(s) 14 is designed to deliver single sheets (or small numbers of sheets) to the shredding mechanism 60. Therefore, if papers are inserted through the input slot 20 above an empty paper station 30 in the auto-feed tray 16 while there is an active auto-feeding operation working on a stack of paper 100 in the other paper station 30, the shredding mechanism 60 will not be overloaded. This is very convenient for the user because once an auto-feed job has started on a single stack of paper 100, it is possible to insert paper 100 through the input slot 20 of the lid 18 without interrupting the auto-feed job and without having to wait for the auto-feed job to complete.

The shredding mechanism 60 is advantageously equipped with the usual safety sensors that stop the operation if the shredding assembly 10 becomes over heated and/or jammed. If a paper jam does occur, a reverse switch on the control assembly 40 is available that reverses the direction of the motor (not shown) so that the jamming paper can be backed out of the shredding mechanism 60. The advantage of not permitting the reversal process until all stacks are removed has been discussed. This makes it relatively easy to look into the slot(s) to locate the jamming paper that is being pushed out.

As shown in FIG. 1, an additional advantage of the extra length (or two side-by-side) shredding mechanisms is that a stack (or single sheets) of oversized paper (such as legal, 8.5 in×14 in or even ledger, 11 in×17 in) can be manually or automatically shredded. Paper guides that define the location of the stack or stack can be reconfigurable to accommodate one or two stack of different dimensions. Without the “double wide” configuration, it would not be possible to shred stack of paper of legal or ledger dimensions.

In accordance with an embodiment of the invention, a dual auto-feed paper shredder includes two (2) side by side paper stations 30. Each station 30 is sized to accommodate one stack of paper 100. Two (2) sets 14 of several pairs 22 of counter-rotating spaced apart rollers are disposed on either side of an input slot 26 in a floor of each of the paper stations 30. Each paper station 30 is associated with a particular one of the sets 14. The shredder also includes a motor-driven shredding mechanism 60 disposed below the input slot 26, and at least one lid 18. The at least one lid 18 includes a spring loaded platen 36. The spring-loaded platen 36 can be disposed partially within the at least one lid 18 and extend from the bottom of the lid 18 (or simply connected to the bottom of the lid 18) so that when the lid 18 is closed after a stack of paper 100 has been placed into the auto-feed tray 16s, contact between the stack of paper 100 and the rollers of the sets 14 is maintained. The shredder also includes a drive system so that the rollers rotate when the shredding mechanism is activated, and a sensor 70 for detecting paper in one or both of the paper stations 30 of the auto-feed tray 16 and activating the shredding mechanism 60 when paper 100 is detected so that the rollers counter-rotate and pull a bottom sheet of paper 100 into the shredding mechanism 60.

In addition, the claimed invention is not limited in size and may be constructed in various sizes in which the same or similar principles of operation as described above would apply. Furthermore, the figures (and various components shown therein) of the specification are not to be construed as drawn to scale.

The terminology used herein is for the purpose of describing particular example embodiments only and is not intended to be limiting. As used herein, the singular forms “a”, “an” and “the” may be intended to include the plural forms as well, unless the context clearly indicates otherwise. In other words, an element or step recited in the singular and preceded by the word “a” or “an” should be understood as not necessarily excluding the plural of the elements or steps. Further, references to “one embodiment” or “one implementation” are not intended to be interpreted as excluding the existence of additional embodiments or implementations that also incorporate the recited features.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. In other words, unless explicitly stated to the contrary, embodiments “comprising” or “having” an element or a plurality of elements having a particular property can include additional elements not having that property. In other words, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. In other words, the use of “including,” “comprising,” “having,” “containing,” “involving,” and variations thereof, is meant to encompass the items listed thereafter and additional items. Further, references to “one embodiment” or “one implementation” are not intended to be interpreted as excluding the existence of additional embodiments or implementations that also incorporate the recited features. The term “exemplary” is intended to mean “an example of”.

When introducing elements of aspects of the disclosure or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” The use of the expression “at least” or “at least one” suggests the use of one or more elements or ingredients or quantities, as the use may be in the embodiment of the disclosure to achieve one or more of the desired objects or results.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary. Any range or value given herein can be extended or altered without losing the effect sought, as will be apparent to the skilled person.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

While various spatial and directional terms, such as “top,” “bottom,” “upper,” “lower,” “vertical,” and the like are used to describe embodiments and implementations of the present disclosure, it is understood that such terms are merely used with respect to the orientations shown in the drawings. The orientations can be inverted, rotated, or otherwise changed, such that a top side becomes a bottom side if the structure is flipped 180 degrees, becomes a left side or a right side if the structure is pivoted 90°, and the like. In other words, spatially relative terms, such as “front,” “rear,” “left,” “right,” “inner,” “outer,” “beneath”, “below”, “lower”, “above”, “upper”, “horizontal”, “vertical”, “lateral”, “longitudinal” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above can relate to one embodiment or can relate to several embodiments. The embodiments are not limited to those that solve any or all of the stated problems or those that have any or all of the stated benefits and advantages. It will further be understood that reference to ‘an’ item refers to one or more of those items.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation (e.g., different steps, etc.) is within the scope of aspects and implementations of the disclosure. In other words, the method steps, processes, and operations described herein are not to be construed as necessarily requiring their performance in the particular order discussed or illustrated, unless specifically identified as an order of performance. It is also to be understood that additional or alternative steps may be employed.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As briefly discussed above, as used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are example embodiments. Many other embodiments will be apparent to those of ordinary skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person of ordinary skill in the art to practice the various embodiments of the disclosure, including making and using any devices or systems and performing any incorporated methods. The patentable scope of the various embodiments of the disclosure is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

The above description presents the best mode contemplated for carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above that are fully equivalent. Moreover, features described in connection with one embodiment of the invention may be used in conjunction with other embodiments, even if not explicitly stated above. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. A dual auto-feed paper shredder comprising:
a housing open at a top side to allow access to a paper compartment disposed within the housing; wherein the paper compartment includes a bottom surface defining two side-by-side paper stations and a centrally located input slot extending across the bottom surface, wherein each paper station is configured to accommodate one stack of paper disposed above the input slot;
two sets of counter-rotating spaced apart rollers disposed on either side of the input slot; wherein each set is associated with a particular one of the paper stations; wherein the housing includes an internal compartment configured to hold a shredding mechanism disposed below the input slot such that sheets of paper pass through the input slot into the shredding mechanism; and
at least one lid hingedly connected to the housing; wherein the at least one lid is rotatable between fully open and fully closed configurations, and the at least one lid is disposed over the paper compartment in the fully closed configuration.

2. The dual auto-feed paper shredder of claim 1, wherein the at least one lid includes a manual feed input slot aligned with the input slot of the paper compartment when the at least one lid is in a fully closed configuration.

3. The dual auto-feed paper shredder of claim 1, wherein each set of counter-rotating spaced apart rollers is configured to operate independent of the other set of counter-rotating spaced apart rollers.

4. The dual auto-feed paper shredder of claim 1, wherein the at least one lid includes a spring-loaded platen configured to maintain contact between the stack of paper and the rollers when the at least one lid is closed after a stack of paper has been placed into at least one of the paper station.

5. The dual auto-feed paper shredder of claim 1, further comprising a sensor configured to detect paper in the paper compartment and activate the shredding mechanism when paper is detected so that the rollers counter-rotate and pull a bottom sheet of paper from the stack of paper and move that sheet of paper through the input slot and into the shredding mechanism.

6. The dual auto-feed paper shredder of claim 1, wherein the at least one lid comprises two lids; wherein each lid is individually connected to the housing such that each lid is moveable between the fully open and fully closed configurations independent of the other lid.

7. The dual auto-feed paper shredder of claim 6, wherein each lid includes a manual feed input slot aligned with the input slot of the paper compartment when the lid is in a fully closed configuration; wherein the manual feed input slots of the lids are aligned when the lids are in the fully closed configuration; and wherein the aligned manual feed input slots are configured to allow either two separate sheets of paper to be passed side-by-side through the aligned manual feed slots into the paper compartment and through the input slot to the shredding mechanism or a single oversized sheet of paper to be passed through the aligned manual feed slots into the paper compartment and through the input slot to the shredding mechanism.

8. The dual auto-feed paper shredder of claim 1, wherein each set of counter-rotating spaced apart rollers is configured to operate independent of the other set.
